(19) United States
(12) Patent Application Publication
(10) Pub. No.: US 2025/0196971 A1
(43) Pub. Date: Jun. 19, 2025

(54) FLOATING PLATFORM SUPPORT SYSTEM WITH PASSIVE OUT-OF-PLANE TENSION LINE DAMPERS

(71) Applicant: Kent Houston Offshore Engineering LLC, Houston, TX (US)

(72) Inventors: Ikpoto E. Udoh, Texas City, TX (US); Vimal Vinayan, Houston, TX (US); Quan Chen, Katy, TX (US)

(21) Appl. No.: 18/542,611

(22) Filed: Dec. 16, 2023

(51) Int. Cl. B63B 21/50; B63B 21/20

(52) U.S. Cl. CPC B63B 21/50; B63B 21/20; B63B 2021/203

(57) ABSTRACT

A support system includes a platform floating at a surface of a body of water, a set of mooring elements, and a set of motion dampers. Each mooring element is rigidly coupled to the platform and to a bottom of the body of water. Each motion damper is coupled to the platform. Each motion damper includes a spool, a line, and a rotation controller. The line is coupled to and partially wound on the spool and has an end rigidly coupled to the bottom of the body of water wherein a tension force in the line is affected by rotation of the spool. The rotation controller is coupled to the spool and is operable to control the rotation of the spool based on the tension force in the line.

### FIELD OF THE DISCLOSURE

This disclosure relates generally to floating platform structures, and more particularly to methods and systems for floating platforms whose dynamic response to environment-induced motion may be damped by passive out-of-plane tension line dampers.

### BACKGROUND

A variety of marine structures may be deployed at offshore locations. Such marine structures may include offshore floating platforms and structures used for wind turbines. In terms of the future of wind turbine design, one such design is a buoyant platform tethered to the sea floor by rigid tendons in tension that must support a very large tubular tower (e.g., on the order of hundreds of feet) with a nacelle mounted at the top of the tower. Rotor blades up to 200 feet or more in length are attached to the nacelle using mechanical and electrical equipment mounted in the nacelle. In order to support such large towers and rotor blades, a wind turbine's floating support platform may need to be quite large in order to compensate for the dynamics of the wind turbine system that will be subjected to environment-induced wave and wind-generated motion. Unfortunately, floating platforms large enough to compensate for wave and water-generated motion require high capital expenditures that may make large wind turbines impractical or impossible to justify.

Rather than relying on a large floating platform for the support of a wind turbine, active and passive control systems have been contemplated for use in “absorbing” or damping wave/wind-induced dynamics acting on a wind turbine system. Active control systems typically rely on an external source of power to constantly power a damping mechanism. This leads to increased operational costs due to the need for constant application of power as well as maintenance. Passive control system approaches are typically based on “tuned mass dampers” (TMD) that are only impactful over some targeted and narrow range of frequencies based on the mass of the structure being damped. Unfortunately, floating-platform-supported wind turbines are subject to several frequencies at which dynamic responses could be the source of structural resonance. In addition, TMDs are extremely difficult to tune in an in-situ field environment such as the open ocean. Accordingly, TMDs do not provide an effective and reliable solution to the damping of resonance of an offshore, floating-platform-supported wind turbine.

### SUMMARY

Accordingly, it is an object of the present disclosure to describe methods and systems for damping motion of offshore floating platforms.

Another object of the present disclosure is to describe methods and systems for passively damping motion of offshore floating platforms.

Still another object of the present disclosure is to describe methods and systems for damping a variety of environment-induced movements of an offshore floating platform used to support a wind turbine system.

Other objects and advantages of the methods and systems described herein will become more obvious hereinafter in the specification and drawings.

In accordance with methods and systems described herein, a support system includes a platform adapted to float at a surface of a body of water. A set of mooring elements are provided with each mooring element being rigidly coupled to the platform and adapted to be rigidly coupled to a bottom of the body of water. Each mooring element is in tension. A set of motion dampers is coupled to the platform. Each motion damper includes a spool, a line, and a rotation controller. The line is coupled to and partially wound on the spool. The line also has an end adapted to be rigidly coupled to the bottom of the body of water wherein a tension force in the line is affected by rotation of the spool. The line is at an acute angle with respect to the bottom of the body of water. The rotation controller is coupled to the spool and is operable to control the rotation of the spool based on the tension force in the line.

### BRIEF DESCRIPTION OF THE DRAWINGS

Other objects, features and advantages of the methods and systems described in the present disclosure will become apparent upon reference to the following description of the preferred embodiments and to the drawings, wherein corresponding reference characters indicate corresponding parts throughout the several views of the drawings and wherein:

FIG. 1 is a schematic view of one embodiment of a floating platform support system having passive out-of-plane tension line dampers in accordance with various aspects as described herein;

FIG. 2 is an isolated schematic view of one embodiment of a motion damper in accordance with various aspects as described herein;

FIG. 3A is an isolated plan view of one embodiment of a floating platform in accordance with various aspects as described herein;

FIG. 3B is an isolated plan view of another embodiment of a floating platform in accordance with various aspects as described herein;

FIG. 4A is a plan view of one embodiment of a triangular platform illustrating a mooring circle and a damping circle in which the mooring and damping circles are coincident in accordance with various aspects as described herein;

FIG. 4B is a perspective view of one embodiment of a floating platform support system using the triangular platform illustrated in FIG. 4A in which the system's mooring elements are anchored along the mooring circle and the system's damper lines are anchored along the damping circle where the mooring and damping circles are coincident in accordance with various aspects as described herein;

FIG. 5A is a plan view of another embodiment of a triangular platform illustrating a mooring circle and a damping circle in which the mooring and damping circles are concentric with the damping circle being larger in accordance with various aspects as described herein;

FIG. 5B is a perspective view of another embodiment of a floating platform support system using the triangular platform illustrated in FIG. 5A in which the system's mooring elements are anchored along the mooring circle and the system's damper lines are anchored along the damping circle where the mooring and damping circles are concentric with the damping circle being larger in accordance with various aspects as described herein;

FIG. 6A is a plan view of another embodiment of a triangular platform illustrating a mooring circle and a damping circle in which the mooring and damping circles are concentric with the damping circle being smaller in accordance with various aspects as described herein;

FIG. 6B is a perspective view of another embodiment of a floating platform support system using the triangular platform illustrated in FIG. 6A in which the system's mooring elements are anchored along the mooring circle and the system's damper lines are anchored along the damping circle where the mooring and damping circles are concentric with the damping circle being smaller in accordance with various aspects as described herein; and

FIG. 7 is a schematic view of another embodiment of a floating platform support system that includes a hybrid tower structure in accordance with various aspects as described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure. However, it will be readily apparent to one of ordinary skill in the art that the present disclosure may be practiced without limitation to these specific details.

The present disclosure describes support systems and methods for passively damping out unwanted motion of a floating platform and any structure supported thereby that may be induced by environmental forces. For example, when the support system is deployed at an offshore location for support of a wind turbine, relevant environmental forces include wind, waves, and water currents. In the presence of such varying and/or cyclical environmental forces, a floating platform and its supported structure may experience movement and resonation at a variety of frequencies.

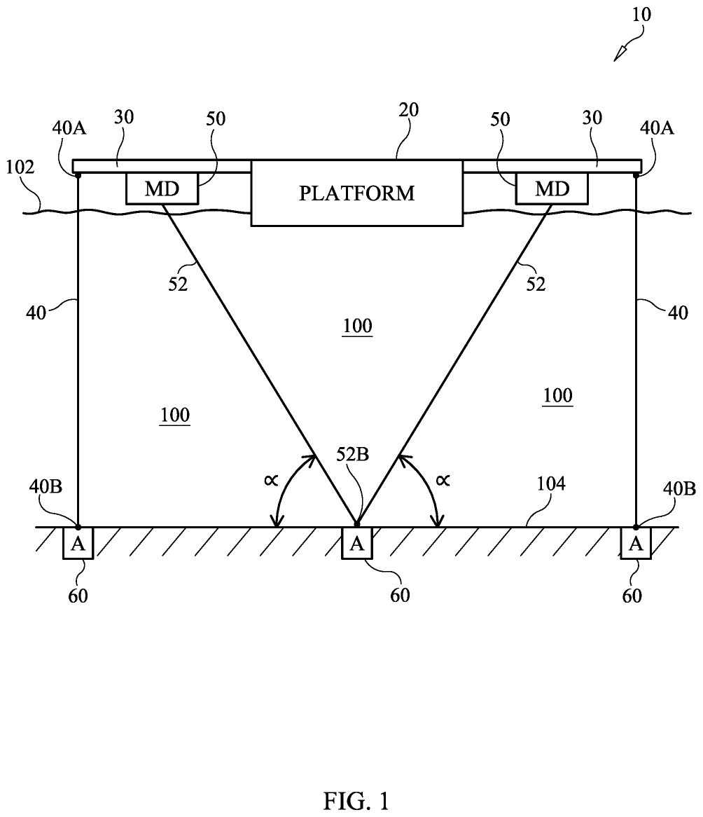

Referring now to the drawings and more particularly to FIG. 1, an embodiment of a floating platform support system in accordance with the present disclosure is illustrated schematically and is referenced generally by numeral 10. Support system 10 includes a platform 20 configured for flotation at or near the surface 102 of a body of water 100. Platform 20 may be configured, sized, and constructed in a variety of ways without departing from the scope of the present disclosure. Several non-limiting embodiments of platform 20 will be presented later herein. In some embodiments, support system 10 may include a supported structure such as a wind turbine's tower, nacelle, and blades. In general, when not under the influence of environmental loads such as wind, waves, and currents, platform 20 lies in a plane coincident with or substantially parallel to the surface 102 of the body of water 100.

In some embodiments and as shown, platform 20 has a set of braces 30 rigidly coupled to the platform. Each of braces 30 provides support for mooring and motion-damping features of support system 10. In some embodiments and as shown, braces 30 may be coupled to a periphery of platform 20 and extend outward from the platform. In some embodiments, braces 30 may be configured to include housing region(s) for the support and/or protection of portions of the mooring and motion-damping features of support system 10. In some embodiments, platform 20 may be configured to incorporate or integrate the functionality of braces 30 directly into the platform's structure without departing from the scope of the present disclosure.

Each brace 30 has one or more mooring elements or tendons 40 rigidly coupled at one end 40A to the brace and rigidly coupled at another end 40B (i.e., anchored) to a location at the bottom 104 of the body of water 100. Each anchored end 40B of a mooring element 40 may be attached to an anchor (“A”) 60 embedded in the bottom 104 of the body of water 100. In general, each mooring element 40 is in tension such that the set of mooring elements 40 associated with support system 10 keeps platform 20 substantially at its installed vertical location, while allowing platform 20 to experience what will be referred to herein as “shifted movement” along the surface 102 of the body of water 100. Such shifted movement is generally caused by one or more of wind, waves, and water currents acting on platform 20 or any structure (not shown in FIG. 1) supported on platform 20.

Support system 10 passively damps the above-described environmentally-induced shifted movement of platform 20 using a set of motion dampers in order to prevent support system 10 (and any structure supported thereon) from resonating or experiencing large dynamic motions at one or more frequencies at which damage may occur. For example, a motion damper (“MD” in the figures) 50 may be coupled to each of braces 30 where each motion damper 50 may be configured to dampen a directional component of any shifted movement of platform 20. As will be explained further below, the set of motion dampers 50 operate to passively damp all directions of environmentally-induced shifted movement of platform 20.

Each motion damper 50 includes a line 52 that extends from one end (not shown in FIG. 1) at brace 30 to its other end 52B rigidly coupled to the bottom 104 of the body of water 100 using, for example, an anchor (“A” in the figures) 60 embedded in the bottom 104. That is, each motion damper's line extends out of the plane of platform 20. In general, line 52 should be made from material(s) that are strong enough to handle the maximum expected loads, stiff to provide motion damper response to small motions of platform 20, lightweight and buoyant to minimize sag, and able to withstand long-term use in a maritime environment. In some embodiments, line 52 may be made from, for example, DYNEEMA fibers available commercially from Avient Corporation.

Each line's end 52B is rigidly anchored to the bottom 104 of the body of water 100 such that an angle α that line 52 makes with the bottom 104 is generally an acute angle selected to insure responsiveness to the above-described shifted movement of platform 20. In some embodiments and as illustrated in FIG. 1, two lines 52 have their ends 52B sharing a common anchor location (e.g., using the same anchor 60) at the bottom 104 of the body of water 100. For example, the two lines 52 sharing a common anchor location may be associated with motion dampers 50 coupled to two adjacent braces 30.

In general, each motion damper 50 may be configured to apply a tension force along its line 52 and then operate to maintain the tension force in order to damp a component of shifted movement of platform 20. To achieve this, each motion damper 50 operates to resist or retard the tension force in its line 52 when platform 20 moves in a way that increases the line's tension force. In addition, each motion damper 50 operates to restore or aid an increase in the tension force in its line 52 when platform 20 moves in a way that decreases the line's tension force. By providing a set of motion dampers 50 in a distributed fashion about platform 20, any shifted movement of platform 20 is readily damped as one or more motion dampers 50 operate to increase tension force in their lines 52, while one or more others of motion dampers 50 simultaneously operate to decrease tension force in their lines 52. Since each motion damper 50 operates independently of all other motion dampers 50, support system 10 readily adapts to varying types, directions, and frequencies of shifted movement of platform 20. The distribution of motion dampers 50 about platform 20 may be an even or irregular distribution depending on an application's needs.

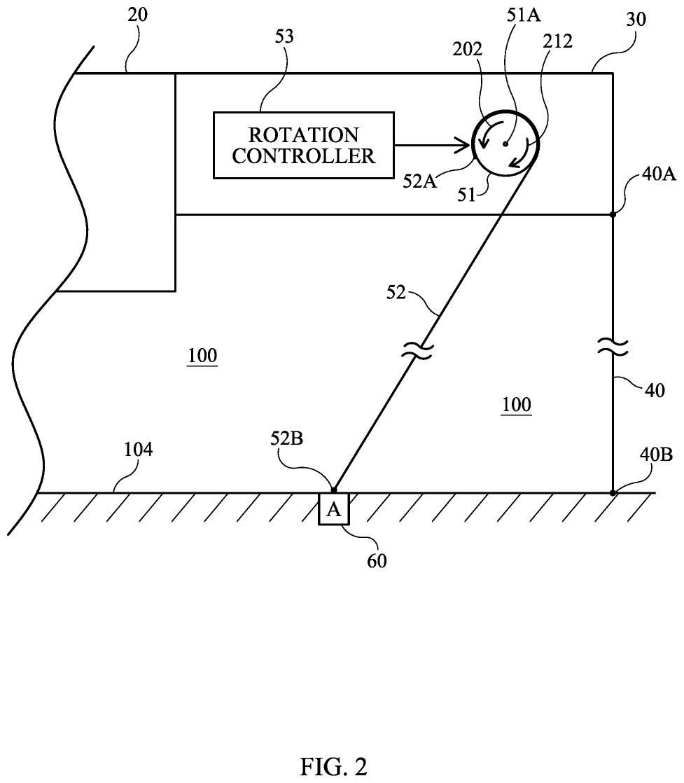

Referring additionally now to FIG. 2, an isolated schematic view of an embodiment of a motion damper 50 is illustrated. In the illustrated example, motion damper 50 includes a spool 51, the above-described line 52, and a rotation controller 53. Spool 51 may be mounted on or in its corresponding brace 30 such that spool 51 may rotate about its axis of rotation 51A. One end 52A of line 52 is coupled to spool 51. One or more wraps of line 52 are wound on spool 51 with the remainder of line 52 being paid out into the water 100 and with end 52B being anchored to the bottom 104 as described above. Rotation controller 53 is coupled to spool 51 to control the rotation of spool 51 in order to apply and maintain a tension force in line 52 that may be altered by shifted movement of platform 20 as described above.

At the installation of support system 10, each of its motion dampers 50 is configured such that each line 52 has a tension force applied there along where the installation tension force is associated with a relatively static condition when shifted movement of platform 20 is negligible or inconsequential. After installation and during operation of the system, line 52 may experience a decrease or increase in its installation tension force where such decrease/increase is indicative of shifted movement of platform 20. For example, when shifted movement of platform 20 causes a decrease in the line's tension force to introduce slack in line 52, rotation controller 53 operates to aid rotation of spool 51 in a rotation direction indicated by arrow 202. That is, when line 52 experiences a decrease in tension force causing slack in line 52, rotation controller 53 causes spool 51 to rotate in a winding direction 202. As spool 51 is rotated in winding direction 202, the slack in line 52 is eliminated to increase the tension force in line 52 in order to damp the shifted movement of platform 20 that caused the decrease in tension force. However, when shifted movement of platform 20 causes an increase in the line's tension force such that spool 51 begins to rotate in an unwinding direction 212 (i.e., opposite to that of winding direction 202), rotation controller 53 operates to retard rotation of spool 51 in its unwinding direction 212. That is, when line 52 experiences an increase in tension force, rotation controller 53 operates to retard the rotation of spool 51 in unwinding direction 212 to thereby damp the platform's shifted movement that caused the increase in the line's tension force.

Rotation controller 53 may be configured in a variety of ways without departing from the scope of the present disclosure. In general, rotation controller 53 may be configured to provide the above-described rotation control of spool 51 in a passive fashion to eliminate the need for any powered devices or systems. For example, in some embodiments, rotation controller 53 may be constructed using one-way clutches and rotational speed brakes or dampers as described in U.S. Pat. No. 11,078,984. In some embodiments, spool 51 and rotation controller 53 may be disposed in wet and dry environments, respectively, of a corresponding brace 30 as a way to reduce or prevent corrosion of rotation controller 53.

As mentioned above, platform 20 may be configured in a variety of ways without departing from the scope of the present disclosure. For example, a floating platform in accordance with the present disclosure may have a footprint at or near the water's surface defined by a polygonal shape having vertices or corners. Such polygonal shapes may include triangles, rectangles, or other multi-sided polygons. In some embodiments, the polygonal shape may utilize identical-length sides (e.g., equilateral triangle, square, etc.) to simplify both the above-described vertical support and motion damping using symmetrical arrangements of support and damping features.

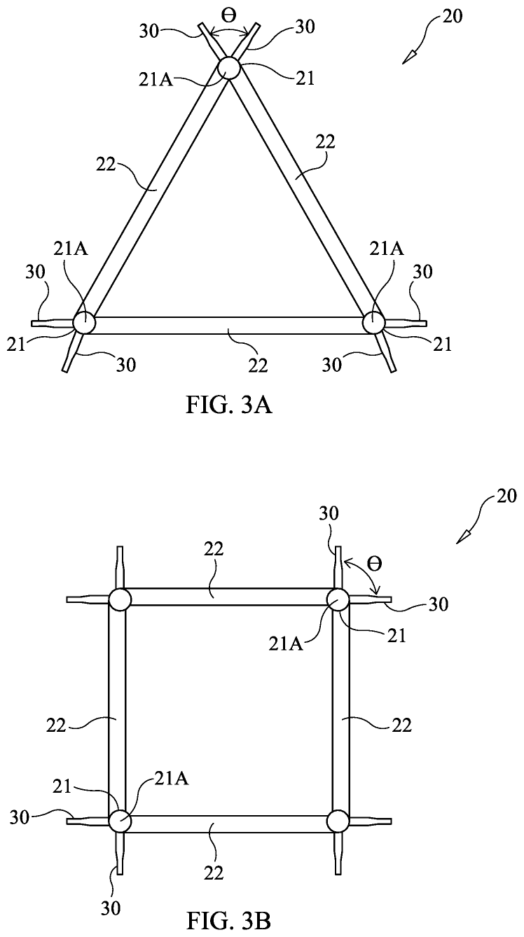

Referring now to FIGS. 3A and 3B, two non-limiting examples of a floating platform and its braces in accordance with the present disclosure are illustrated in isolated plan views. In FIG. 3A, platform 20 is configured such that its outer periphery defines or approximates an equilateral triangle with columns 21 at the triangle's vertices and with pontoons 22 coupled to and extending between two columns 21 to thereby form a side of the equilateral triangle. Each column 21 supports two of braces 30 that extend outward from the periphery of platform 20. An angle θ between two braces 30 associated with a column 21 may be varied based on the needs of an installation. The top 21A of each column 21 may form the base for a supported structure (not shown). In FIG. 3B, platform 20 is configured such that its outer periphery defines or approximates a square with columns 21 at the square's corners and with pontoons 22 coupled to and extending between two columns 21 to thereby form a side of the square. Each column 21 supports two of braces 30 that extend outward from the periphery of platform 20. The angle θ between two braces 30 associated with a column 21 may be varied based on the needs of an installation. Once again, the top 21A of each column 21 may form the base for a supported structure (not shown).

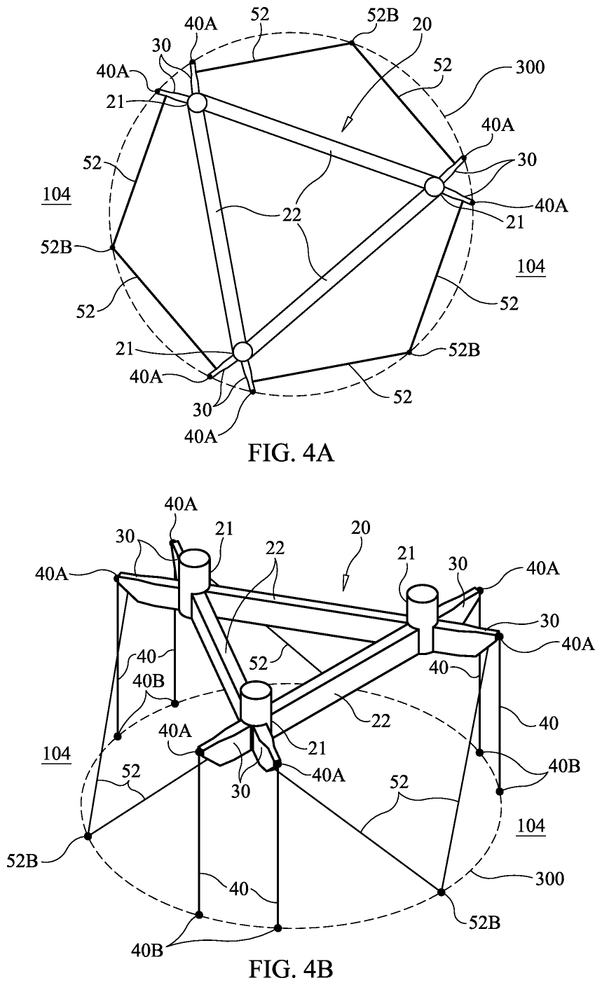

Support systems in accordance with the present disclosure may be configured for symmetrical support and symmetrical motion damping. Several non-limiting exemplary embodiments of such support systems will be described with reference to the corresponding pairs of FIGS. 4A and 4B, FIGS. 5A and 5B, and FIGS. 6A and 6B. In each of the “A” figures, an isolated plan view of a floating platform and projections of its potential mooring and damping locations are illustrated. In each of the “B” figures, a perspective view of an embodiment of a floating platform support system based on the corresponding “A” figure is illustrated. For clarity of illustration, only lines 52 associated with each motion damper are illustrated.

Referring to FIGS. 4A and 4B, platform 20 has both of its mooring elements 40 and lines 52 anchored to locations that lie on or approximately on a circle indicated by dashed line 300. The circle 300 is essentially a planar projection of a circle at or near the bottom 104 of the body of water 100. That is, it is to be understood that the bottom 104 may not be a planar surface such that the anchoring of mooring elements 40 and lines 52 may occur at different depths of the body of water 100 yet still lie on circle 300. The diameter of circle 300 may be defined by the anchoring locations of mooring elements 40. For example, mooring elements 40 may be oriented vertically such that each mooring element 40 is normal or approximately normal to the surface 102 of the body of water 100. In this illustrated example, all ends 40B of mooring elements 40 and all ends 52B of lines 52 lie on or approximately on circle 300. In other words, circle 300 defines coincident mooring and damping circles. Ends 52B of lines 52 between adjacent braces 30 may share a common anchor location on or approximately on circle 300 as illustrated. The common anchor locations for two lines 52 may be halfway between the two corresponding adjacent braces 30.

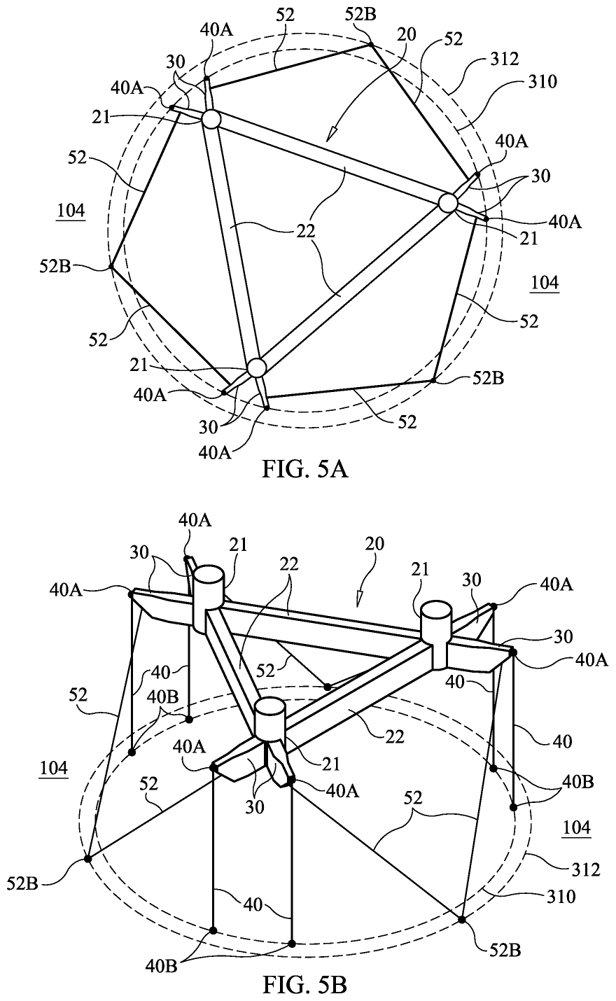

Referring now to FIGS. 5A and 5B, platform 20 has its mooring elements 40 anchored to locations that lie on or approximately on a mooring circle 310, while lines 52 are anchored to locations that lie on or approximately on a damping circle 312. Circles 310 and 312 are planar projections of concentric circles at/near the bottom 104 of the body of water 100 where damping circle 312 is larger than mooring circle 310. Once again, the diameter of mooring circle 310 may be defined by vertical installations of mooring elements 40 that are normal or approximately normal to the surface 102 of the body of water 100. In this illustrated example, all ends 40B of mooring elements 40 lie on or approximately on mooring circle 310, while all ends 52B or lines 52 lie on or approximately on the larger damping circle 312. Ends 52B of lines 52 between adjacent braces 30 may share a common anchor location on or approximately on damping circle 312 as illustrated. The common anchor locations for two lines 52 may be halfway between the two corresponding adjacent braces 30.

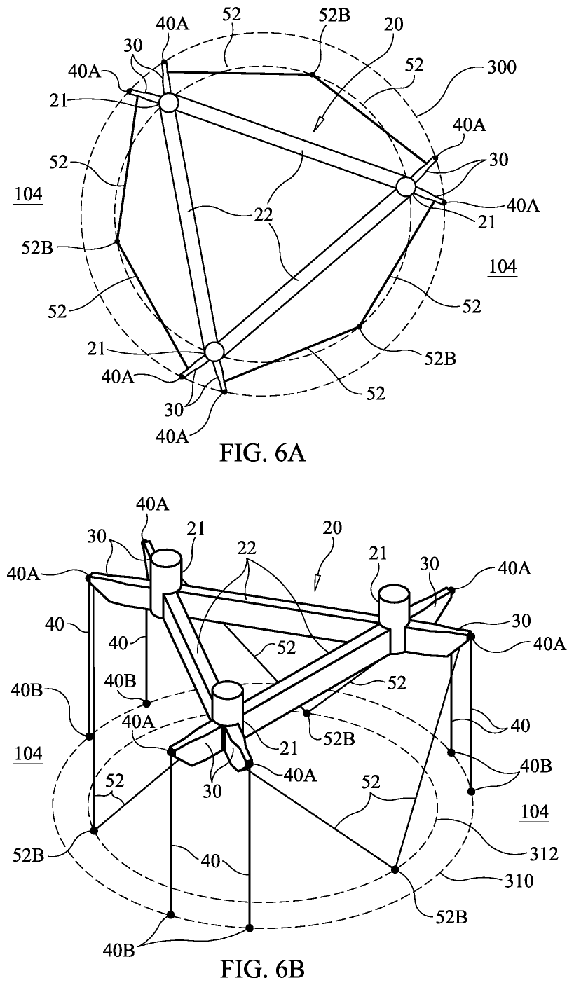

Referring now to FIGS. 6A and 6B, platform 20 has its mooring elements 40 anchored to locations that lie on or approximately on a mooring circle 310, while lines 52 are anchored to locations that lie on or approximately on a damping circle 312. Circles 310 and 312 are planar projections of concentric circles at/near the bottom 104 of the body of water 100 where damping circle 312 is smaller than mooring circle 310. Once again, the diameter of mooring circle 310 may be defined by vertical installations of mooring elements 40 that are normal or approximately normal to the surface 102 of the body of water 100. In this illustrated example, all ends 40B of mooring elements 40 lie on or approximately on mooring circle 310, while all ends 52B or lines 52 lie on or approximately on the smaller damping circle 312. Ends 52B of lines 52 between adjacent braces 30 may share a common anchor location on or approximately on damping circle 312 as illustrated. The common anchor locations for two lines 52 may be halfway between the two corresponding adjacent braces 30.

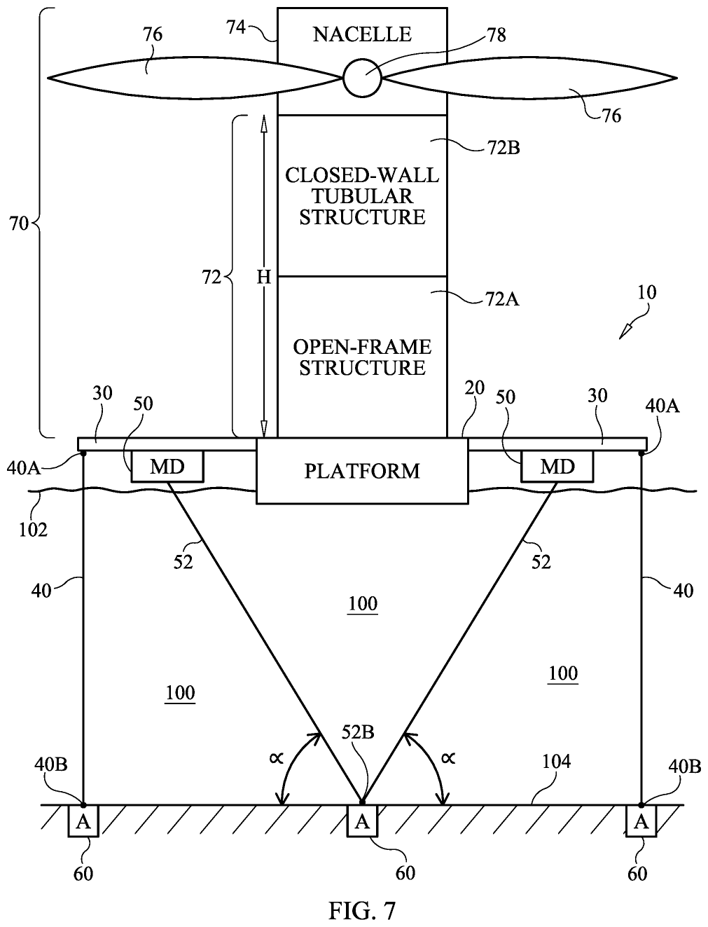

As mentioned above, support systems in accordance with the present disclosure may include a supported structure disposed on the support system's platform. For example, a wind turbine may be mounted on the support system's platform. In general and as is well-known in the art, wind turbines include a tubular solid-wall support tower, a nacelle housing a generator, gear box, bearings, etc. mounted atop the support tower, and blades coupled to a rotating hub extending from the nacelle. In accordance with the present disclosure and as illustrated in FIG. 7, the above described support system may include a wind turbine 70 that includes a hybrid tower 72, a nacelle 74 (housing a generator, gear box, bearings, etc.), and blades 76 coupled to a rotating hub 78 extending from nacelle 74. In accordance with an aspect of the present disclosure, hybrid tower 72 includes a lower portion 72A constructed as an open-frame structure (e.g., an open truss frame construction) and an upper portion 72B constructed as a closed-wall tubular structure (i.e., solid outer walls). The height of upper portion 72B may be up to approximately 50% of the overall height “H” of tower 72. The open framework of lower portion 72A will make it less susceptible to wind impacts, while the closed outer wall structure of upper portion 72B will allow tower 72 to interface with the components at the top of tower 72 in accordance with currently-accepted and approved constructions.

The advantages of the systems and methods described herein are numerous. The disclosed support system passively damps shifted movement of a floating platform. The multiple motion dampers may be distributed about the periphery of a floating platform to damp the platform's shifted movements in a variety of directions. Since each motion damper operates independently, the support system is able to adapt to and damp motion over a variety of frequencies thereby making the support system ideally suited for inclusion as part of an offshore wind turbine installation.

Although the methods and systems presented herein have been described for specific embodiments thereof, there are numerous variations and modifications that will be readily apparent to those skilled in the art in light of the above teachings. For example, motion dampers described herein may additionally or alternatively be disposed along sides of a platform. The hybrid tower described herein may also be used with other types of floating or land-based installations. It is therefore to be understood that, within the scope of the appended claims, the methods and systems presented herein may be practiced other than as specifically described.

What is claimed as new and desired to be secured by Letters Patent of the United States is:

1. A support system, comprising:
a platform adapted to float at a surface of a body of water;
a set of mooring elements, each mooring element from said set of mooring elements rigidly coupled to said platform and adapted to be rigidly coupled to a bottom of the body of water, each said mooring element being in tension; and
a set of motion dampers coupled to said platform, each motion damper from said set of motion dampers including
a spool,
a line coupled to and partially wound on said spool, said line further having an end adapted to be rigidly coupled to the bottom of the body of water wherein a tension force in said line is affected by rotation of said spool, said line being at an acute angle with respect to the bottom of the body of water, and
a rotation controller coupled to said spool and operable to control said rotation of said spool based on said tension force.

2. The support system of claim 1, wherein a periphery of said platform comprises a polygonal shape having corners.

3. The support system of claim 2, further comprising a set of braces coupled to said platform at each of said corners.

4. The support system of claim 1, further comprising:
a tower coupled to said platform and adapted to extend above the surface of the body of water, said tower including an open frame structure rigidly coupled to said platform and a closed tubular structure rigidly coupled to said open frame structure.

5. The support system of claim 4, wherein said tower has a height, and wherein said closed tubular structure comprises up to approximately 50% of said height.

6. The support system of claim 3, further comprising a set of anchors adapted to be rigidly coupled to the bottom of the body of water, each anchor from said set of anchors being associated with two braces from said set of braces wherein each said line associated with said two braces is rigidly coupled to said anchor.

7. The support system of claim 6, wherein said anchors are distributed about a perimeter of a geometric shape that approximates a circle.

8. The support system of claim 1, wherein said mooring elements are rigidly coupled to the bottom of the body of water at locations that lie approximately on a perimeter of a first circle, wherein each said line is rigidly coupled to the bottom of the body of water at a location that lies approximately on a perimeter of a second circle, and wherein a diameter of said second circle is larger than a diameter of said first circle.

9. The support system of claim 1, wherein said mooring elements are rigidly coupled to the bottom of the body of water at locations that lie approximately on a perimeter of a first circle, wherein each said line is rigidly coupled to the bottom of the body of water at a location that lies approximately on a perimeter of a second circle, and wherein said first circle and said second circle comprise concentric circles.

10. A support system, comprising:
a platform having a periphery, said platform adapted to float at a surface of a body of water;
a set of braces, each brace from said set of braces rigidly coupled to said periphery of said platform and extending out from said periphery;
a set of tensioned mooring elements, each tensioned mooring element from said set of tensioned mooring elements rigidly coupled to one of said braces and adapted to be rigidly coupled to a bottom of the body of water, said tensioned mooring elements rigidly coupled to the bottom of the body of water at locations that lie approximately on a perimeter of a first circle; and
a motion damper coupled to each of said braces, each said motion damper including
a spool having an axis of rotation, said spool being operable to rotate about said axis of rotation,
a line coupled to and partially wound on said spool, said line further having an end adapted to be rigidly coupled to the bottom of the body of water at a location that lies approximately on a perimeter of a second circle wherein a tension force in said line is affected by rotation of said spool, said line being at an acute angle with respect to the bottom of the body of water, and
a rotation controller coupled to said spool and operable to control said rotation of said spool based on said tension force, wherein a first direction of said rotation is retarded and wherein a second direction of said rotation is aided.

11. The support system of claim 10, wherein said first circle and said second circle are concentric.

12. The support system of claim 10, wherein said first circle and said second circle are coincident.

13. The support system of claim 10, wherein said periphery of said platform comprises a polygonal shape having corners.

14. The support system of claim 13, wherein two of said braces are coupled to said platform at each of said corners.

15. The support system of claim 10, further comprising:
a tower coupled to said platform and adapted to extend above the surface of the body of water, said tower including an open frame structure rigidly coupled to said platform and a closed tubular structure rigidly coupled to said open frame structure.

16. The support system of claim 15, wherein said tower has a height, and wherein said closed tubular structure comprises approximately 50% of said height.

17. The support system of claim 10, further comprising a set of anchors adapted to be rigidly coupled to the bottom of the body of water, each anchor from said set of anchors being associated with two adjacent braces from said set of braces wherein each said line associated with said two adjacent braces is rigidly coupled to said anchor.

18. A support system, comprising:
a platform adapted to float at a surface of a body of water;
a set of braces, each brace from said set of braces rigidly coupled to said platform;
a set of tensioned mooring elements, each tensioned mooring element from said set of tensioned mooring elements rigidly coupled to one of said braces and adapted to be rigidly coupled to a bottom of the body of water, said tensioned mooring elements rigidly coupled to the bottom of the body of water at locations that lie approximately on a perimeter of a first circle;
a motion damper coupled to each of said braces, each said motion damper including
a spool having an axis of rotation, said spool being operable to rotate about said axis of rotation,
a line coupled to and partially wound on said spool, said line further having an end adapted to be rigidly coupled to the bottom of the body of water at a location that lies approximately on a perimeter of a second circle wherein a tension force in said line is affected by rotation of said spool, and
a rotation controller coupled to said spool and operable to retard a first direction of said rotation and aid a second direction of said rotation; and
said first circle and said second circle being concentric.

19. The support system of claim 18, wherein a periphery of said platform comprises a polygonal shape having corners.

20. The support system of claim 19, wherein two of said braces are coupled to said platform at each of said corners.

21. The support system of claim 18, further comprising:
a tower coupled to said platform and adapted to extend above the surface of the body of water, said tower including an open frame structure rigidly coupled to said platform and a closed tubular structure rigidly coupled to said open frame structure.

22. The support system of claim 21, wherein said tower has a height, and wherein said closed tubular structure comprises approximately 50% of said height.

23. The support system of claim 18, further comprising a set of anchors adapted to be rigidly coupled to the bottom of the body of water, each anchor from said set of anchors being associated with two adjacent braces from said set of braces wherein each said line associated with said two adjacent braces is rigidly coupled to said anchor.
